(19) United States
(12) Patent Application Publication
(10) Pub. No.: US 2005/0115509 A1
(43) Pub. Date: Jun. 2, 2005

(54) Litter box

(76) Inventor: Carol Rudolph, Columbus, OH (US)

Correspondence Address: PORTER WRIGHT MORRIS & ARTHUR, LLP;INTELLECTUAL PROPERTY GROUP, 41 SOUTH HIGH STREET, 28TH FLOOR, COLUMBUS, OH, 43215, US

(21) Appl. No.: 10/713,598

(22) Filed: Nov. 14, 2003

(51) Int. Cl. A01K 29/00

(52) U.S. Cl. 119/165

(57) ABSTRACT

A one-piece litter box for an animal includes a container having a base wall with sidewalls extending vertically upward from edges of the base wall to form a hollow interior space. A top opening is formed by upper edges of the sidewalls and an entrance opening is formed in one of the sidewalls. The entrance opening is free of coverings so that the animal can see through the entrance opening. The sidewalls form a height of the container which substantially prevents the animal from seeing over the sidewalls while standing within the hollow interior space so that the animal faces the entrance opening while within the hollow interior space. The tall sidewalls and the fact the animal faces the entrance opening enables the litter box to avoid litter from escaping. The size, shape and location of the entrance opening further enhances retention of litter within the container.

### CROSS-REFERENCE TO RELATED APPLICATIONS

Not Applicable

### STATEMENT REGARDING FEDERALLY SPONSORED RESEARCH

Not Applicable

### REFERENCE TO MICROFICHE APPENDIX

Not Applicable

### FIELD OF THE INVENTION

The present invention generally relates to an improved litter box and, more particularly, to a litter box having relatively high sidewalls to better retain litter and the like within the litter box.

### BACKGROUND OF THE INVENTION

A cat instinctively seeks to bury its excrement by digging and scratching litter or whatever else is present. At times this digging and scratching can be quite vigorous. As a result, litter is frequently thrown out of conventional litter boxes. Additionally, male cats are known to spray urine out of conventional litter boxes. Many attempts have been made to design a litter box from which no litter, feces, or urine escapes. For example see U.S. Pat. Nos. 3,310,031, 5,590,623, D370,094, D370,095, and D392,076 the disclosures of which are each expressly incorporated herein in their entirety by reference.

U.S. Pat. No. 3,310,031 discloses a “Sanitary Cat Box” which includes a material retaining structure that substantially extends the height of the end walls of the litter box but not the sidewalls of the litter box. As a result, the sidewalls do not adequately retain litter, feces, and urine within the litter box. Additionally, an interface between the material retaining structure and the litter box can form a trap, particularly for urine, which not only can require more frequent cleaning of the litter box but also makes cleaning of the litter box more difficult and unsanitary.

U.S. Pat. No. 5,590,623 discloses a “Cat Litter Box” which has no side openings and no doors or flaps to admit cats. This litter box requires cats to enter through the top of the litter box using their natural jumping ability. An attempt is made to make sidewalls of the box tall enough to prevent the escape of litter yet low enough to permit entry by a cat over the sidewalls. This compromise in height, however, can permit the escape of litter, feces, or urine in some cases, such as with a vigorous scratcher or very large cats, and can prevent the entry of the cat into the litter box in other cases, such as with injured, handicapped, or extremely old cats. Additionally, this litter box is formed of separate upper and lower sections which are secured together. As noted above, this interface between the separate sections can form a trap, particularly for urine, which not only can require more frequent cleaning of the litter box but also makes cleaning of the litter box more difficult and unsanitary

U.S. Pat. Nos. 3,310,031, 5,590,623, D370,094, D370,095, and D392,076 each disclose a “Cat Litter Box” having a removable lid which closes the top of the litter box. While such lids prevent entry of cats through the top opening of the litter box, these lids reduce and/or eliminate ventilation of the litter box. Without adequate ventilation, finicky cats can quickly refuse to use the litter box resulting in more frequent cleaning of the litter box. Additionally, as noted above, the interface between the lid and the litter box can form a trap, particularly for urine, which not only can require more frequent cleaning of the litter box but also makes cleaning of the litter box more difficult and unsanitary.

While many attempts have been made to design litter boxes from which no litter, feces, or urine escapes, applicant is not aware of any litter box which does not have at least one of the above-noted problems or limitations. Accordingly, there remains need in the art for an improved litter box.

### SUMMARY OF THE INVENTION

The present invention provides a litter box which overcomes at least some of the above-noted problems of the related art. According to the present invention, a one-piece litter box for an animal comprises, in combination, a container having a base wall with sidewalls extending vertically upward from edges of the base wall to form a hollow interior space. A top opening is formed by upper edges of the sidewalls and an entrance opening is formed in one of the sidewalls. The entrance opening is free of coverings so that the animal can see through the entrance opening. The sidewalls form a height of the container which substantially prevents the animal from seeing over the sidewalls while standing within the hollow interior space so that the animal faces the entrance opening while within the hollow interior space.

According to yet another aspect of the present invention, a one-piece litter box comprises, in combination, a container having a base wall with sidewalls extending vertically upward from edges of the base wall to form a hollow interior space. A top opening is formed by upper edges of the sidewalls and an entrance opening is formed in one of the sidewalls. The sidewalls form a height of the container which is at least fifteen inches while the entrance opening is spaced at least six inches above the bottom wall of the container. The entrance opening is circular and has a diameter in the range of about eight inches to about ten inches.

From the foregoing disclosure and the following more detailed description of various preferred embodiments it will be apparent to those skilled in the art that the present invention provides a significant advance in the technology of litter boxes. Particularly significant in this regard is the potential the invention affords for providing a high quality, reliable, inexpensive, and easily cleaned product. Additional features and advantages of various preferred embodiments will be better understood in view of the detailed description provided below.

### BRIEF DESCRIPTION OF THE DRAWINGS

These and further features of the present invention will be apparent with reference to the following description and drawings, wherein:

FIG. 1 is a perspective view of a litter box according to a preferred embodiment of the present invention;

FIG. 2 is a front elevational view of the litter box of FIG. 1;

FIG. 3 is a cross-sectional view taken along line 3-3 of FIG. 2; and

FIG. 4 is a top plan view of the litter box of FIGS. 1 to 3.

It should be understood that the appended drawings are not necessarily to scale, presenting a somewhat simplified representation of various preferred features illustrative of the basic principles of the invention. The specific design features of the litter box as disclosed herein, including, for example, specific dimensions, orientations, and shapes of the various components will be determined in part by the particular intended application and use environment. Certain features of the illustrated embodiments have been enlarged or distorted relative to others to facilitate visualization and clear understanding. In particular, thin features may be thickened, for example, for clarity or illustration. All references to direction and position, unless otherwise indicated, refer to the orientation of the litter box illustrated in the drawings. In general, up or upward refers to an upward direction within the plane of the paper in FIG. 2 and down or downward refers to a downward direction within the plane of the paper in FIG. 2.

### DETAILED DESCRIPTION OF CERTAIN PREFERRED EMBODIMENTS

It will be apparent to those skilled in the art, that is, to those who have knowledge or experience in this area of technology, that many uses and design variations are possible for the improved litter box disclosed herein. The following detailed discussion of various alternative and preferred embodiments will illustrate the general principles of the invention with reference to a litter box for use with domestic felines or cats. Other embodiments suitable for other applications, such as litter boxes for other animals such as rabbits, ferrets, or other household pets, will be apparent to those skilled in the art given the benefit of this disclosure.

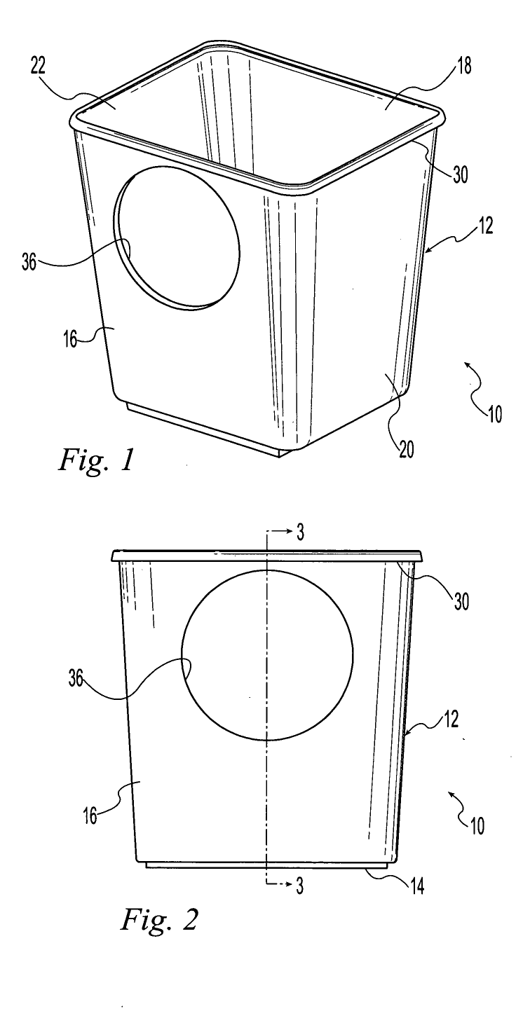

Referring now to the drawings, FIGS. 1 to 4 show a litter box 10 according to a preferred embodiment of the present invention. The illustrated litter box 10 is in the form of a unitary or one-piece box or container 12 having a bottom or base wall 14 and sidewalls 16, 18, 20, 22 upwardly extending from peripheral edges of the base wall 14 to form a hollow interior space 24. The term unitary and one-piece is used within the specification and claims to mean a single piece or component of continuous material formed such as, for example, by molding. The width of each of the sidewalls 16, 18, 20, 22 is sufficiently sized so that the hollow interior space 24 can hold a cat. The width of each sidewall 16, 18, 20, 22 is preferably at least about ten inches and more preferably at least about fourteen inches. The height of each of the sidewalls 16, 18, 20, 22 is sufficiently sized so that the spraying of urine or the escape of litter or feces over the sidewalls 16, 18, 20, 22 is avoided, that is, the height is preferably at least eye level to an average cat and more preferably taller than the height of an average cat. Accordingly, each of the sidewalls 16, 18, 20, 22 preferably have a height of at least about fifteen inches, more preferably a height of at least about eighteen inches, and even more preferably a height of at least about twenty inches. The illustrated base wall 14 is rectangular-shaped but other suitable shapes such as, for example, a square, triangle, pentagon, hexagon, or the like can be utilized within the scope of the present invention. This interface between the base wall 14 and the sidewalls 16, 18, 20, 22 are preferably rounded to ease cleaning of the container 12. The interface preferably has a radius of at least about one-half inch and more preferably a radius of at least about three-quarters of an inch. The interface between adjacent ones of the sidewalls 16, 18, 20, 22 is also preferably rounded to ease cleaning of the container 12. This interface preferably has a radius of at least about one inch and more preferably a radius of at least about two inches.

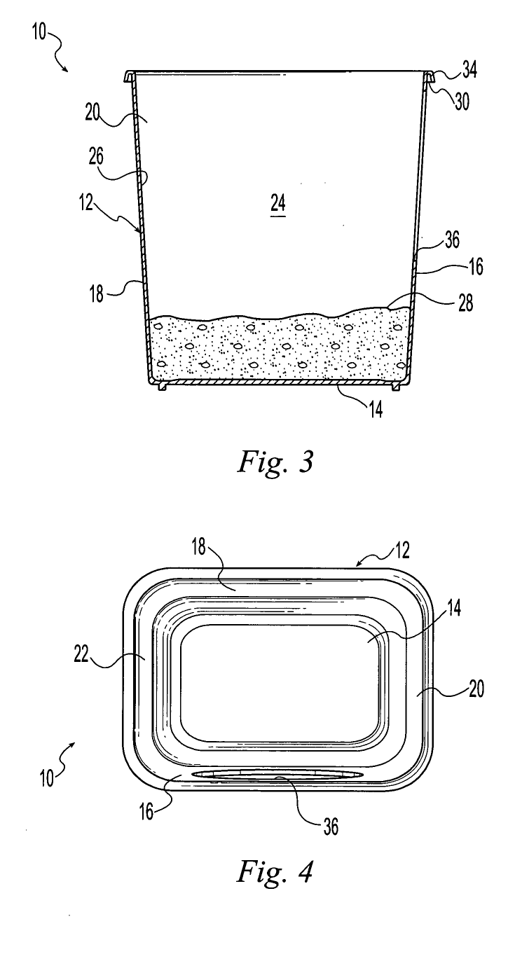

As best shown in FIG. 3, the base wall 14 and the sidewalls 16, 18, 20, 22 of the illustrated container 12 are seamless so that the interior surface 26 of the container 12 is smooth and continuous (other than a single opening as described in more detail hereinafter). This smooth and continuous interior surface 26 is free of sharp corners, channels, cracks, seams, and other traps which can hold litter, feces, and urine. Therefore, not only is cleanup easier, but urine is not trapped away from the absorbent litter 28 which can cause odor and unsanitary conditions which result in the need for more frequent cleaning. The smooth and continuous interior surface 26 also enables the container 12 to be easily used and cleaned without liners which themselves can be urine traps. While it is preferred that the litter box 10 is used without liners, it is noted that alternatively the litter box 10 can be used with liners but some of the advantages of the present invention may not be fully appreciated. When using a liner, the liner can be relatively short, that is located entirely below the entrance opening 36 and secured to the sidewalls in a suitable manner such as, for example, tape. Alternatively, the liner can be relatively tall so that it extends to and is secured about the lip 30. It is believed that suitably sized off-the-shelf kitchen trash bags are available which can adequately serve this purpose. When using these tall liners, it is necessary to cut a suitable opening which is located at the entrance opening 36 and it may be desirable to tape or otherwise secure the liner at the edge of the entrance opening 36.

Upper edges of the sidewalls 16, 18, 20, 22 form a lip 30 defining a top opening 32 for the container 12 to stiffen the sidewalls 16, 18, 20, 22. The illustrated lip 30 is in the form of an inverted-j so that the lip 30 extends outwardly and downwardly from the upper edge of the sidewalls 16, 18, 20, 22. The lip 30 preferably forms a rounded upward-facing surface 34 and preferably has a width which is sufficiently narrow to prevent, or at least discourage, cats from standing thereon which could tip or overturn the litter box 10. The lip 30 preferably has a width of no more than one-half inch. The top opening 32 is preferably entirely open and free of any covers, screens, lids, shields, or the like to avoid urine traps, provide ventilation, and ease clean-up.

One of the sidewalls 16 is provided with an entrance opening 36 of suitable size and shaped for ingress and egress of a cat therethrough but no larger than necessary so that the spraying of urine or the escape of litter or feces therethrough is avoided or at least minimized. The entrance opening 36 is preferably circular or at least having a rounded lower edge to minimize the size of the entrance opening 36 near its lower end. The entrance opening 36 is preferably in the shape of a circle having a diameter in the range of about eight to about ten inches, and more preferably having a diameter of about nine inches. The lower end of the entrance opening 36 is preferably spaced above the base wall 14 an adequate distance which easily permits the passage of cats through the entrance opening 36 but is spaced above the litter 28 an adequate distance so that the spraying of urine or the escape of litter or feces through the entrance opening 36 is avoided or at least minimized. It has been determined that a spacing of about six inches is optimal for use of litter 28 having a depth of about three inches. Thus, the entrance opening 36 is preferably located above at least forty percent of the height of the sidewall 16. The entrance opening 36 of the illustrated rectangular container 12 is located in one of the sidewalls 16, 18 of longer length, but it is noted that the entrance opening 36 can alternatively be located in one of the sidewalls 20, 22 of shorter width, particularly where the container 12 has relatively small dimensions so that the cat freely faces the entrance opening 36 when within the container 12. The entrance opening 36 is preferably centered on the sidewall 16 so that the cat can easily look out of the entrance opening 36 from within the container 12.

The entrance opening 36 is preferably the only opening in the sidewalls 16, 18, 20, 22, that is, the sidewalls 16, 18, 20, 22 are preferably smooth and continuous except for the single opening 36. Also, the entrance opening 36 is preferably free of doors, shields, covers and the like which can be urine traps and complicate cleaning of the litter box 10. It has been determined that when the sidewalls 16, 18, 20, 22 are tall enough to obscure the view of the cat, most cats will turn to face the entrance opening 36 while within the container 12 so that they can see out of the container 12. With the cat facing the entrance opening 36 and the remaining sidewalls 18, 20, 22 being free of any openings, the spraying of urine or the escape of litter or feces through the entrance opening 36 is substantially avoided even though the entrance opening 36 is located in one of the sidewalls 16, 18, 20, 22. Note that a cat typically does not spray urine or scratch litter forward toward it head.

The container 12 can be formed of any suitable material and in any suitable manner. The container 12 is preferably molded of a suitable plastic material. The entrance opening 36 can be molded in place or formed by cutting after the container 12 is molded. The container material is preferably an opaque material so that the cat cannot see through the sidewalls 16, 18, 20, 22 and must face the entrance opening 36 to see out of the container 12. The container 12 can be advantageously include antibacterial or antimicrobial material such as, for example, MICROBAN so that the litter box has additional sanitary protection.

The illustrated embodiment of the litter box 10 can be produced from an off-the-shelf base container such as a seven-gallon plastic wastebasket having a length of about fourteen and one-half inches, a width of about ten and one-half inches, and a height of about fifteen inches which is available from Universal Office Products, Inc. Another suitable base container is believed to be an eighteen gallon plastic storage tote having a length of twenty-four inches, a width of about seventeen inches, and a height of about fifteen inches which is available from Sterilite Corporation. It is noted that these base containers are provided as examples only and that many other containers meet the desired features discussed in detail hereinabove.

To use the litter box 10, a layer of the litter or other suitable absorbent material 28 is preferably placed in the bottom of the container 12 directly on the base wall 14. The layer of litter 28 preferably has a depth of about three inches. A cat enters the litter box 10 through the entrance opening 36. A cat will typically not enter through the top opening 32 because the sidewalls 16, 18, 20, 22 do not enable the cat to see in and the lip 30 is not wide enough to support the cat. Once inside the container 12, the cat naturally turns to face the entrance opening 36 so that it can see out of the container 12 since it cannot see over the sidewalls 16, 18, 20, 22. Upon relieving itself and scratching and digging the litter 28, any flying litter, feces, and urine contacts the continuous sidewalls 18, 20, 22 and remains within the container 12 as the cat faces the entrance opening 36. The cat then exits the entrance opening 36. When the litter box 10 is to be cleaned, any contents are simply poured into a trash bag or the like and the interior of the container 12 is flushed with water and/or other cleaning solution and is easily wiped clean. The litter box 10 is then clean and ready for reuse.

It is apparent from the above detailed description that the relatively tall sidewalls and the shape, size, and location of the entrance opening avoids litter, feces, and urine from being ejected from the litter box. It is also apparent that, the invention is relatively inexpensive to manufacture, is lightweight, reduces maintenance and labor, and can be easily cleaned by scooping clumped litter through the top opening. Because it is lightweight, the litter box can be easily tipped and emptied by tilting and pouring the litter out of the container. It is additionally apparent, that the one-piece design of the litter box eliminates the need for assembly and any urine traps produced by prior multi-component designs.

From the foregoing disclosure and detailed description of certain preferred embodiments, it will be apparent that various modifications, additions and other alternative embodiments are possible without departing from the true scope and spirit of the present invention. The embodiments discussed were chosen and described to provide the best illustration of the principles of the present invention and its practical application to thereby enable one of ordinary skill in the art to utilize the invention in various embodiments and with various modifications as are suited to the particular use contemplated. All such modifications and variations are within the scope of the present invention as determined by the appended claims when interpreted in accordance with the benefit to which they are fairly, legally, and equitably entitled.

1. A one-piece litter box for an animal comprising, in combination:
a container having a base wall with sidewalls extending vertically upward from edges of the base wall to form a hollow interior space;
wherein a top opening is formed by upper edges of the sidewalls;
wherein an entrance opening is formed in one of the sidewalls;
wherein the entrance opening is circular and has a diameter in the range of about eight inches to about ten inches;
wherein the entrance opening is spaced below the top opening of the container and spaced at least six inches above the base wall of the container;
wherein the entrance opening is laterally centered on the sidewall in which the entrance opening is formed;
wherein the sidewalls are free of any openings other than the entrance opening;
wherein the entrance opening is free of coverings so that the animal can see through the entrance opening;
wherein the sidewalls form a height of the container which substantially prevents the animal from seeing over the sidewalls while standing within the hollow interior space; and
whereby the animal faces the entrance opening while within the hollow interior space to see out of the container through the entrance opening and thereby substantially avoid escape of urine feces and litter through the entrance opening while the animal is within the container.

2. The litter box according to claim 1, wherein each of the sidewalls are continuous except for the entrance opening.

3. The litter box according to claim 1, wherein the height of the container is at least fifteen inches.

4. (canceled)

5. (canceled)

6. (canceled)

7. (canceled)

8. (canceled)

9. The litter box according to claim 1, wherein the entrance opening is spaced above a bottom of the container a distance equal to at least forty percent of the height of the container.

10. The litter box according to claim 1, wherein the top opening is entirely open and free of any covering.

11. The litter box according to claim 1, wherein the container is molded of an opaque plastic material.

12. The litter box according to claim 1, wherein the container is molded of a plastic material including an antimicrobial material.

13. The litter box according to claim 1, wherein the upper edges of the sidewalls form a lip having a round upward-facing surface.

14. The litter box according to claim 1, wherein the upper edges of the sidewalls form a lip having a width of no more than one-half inch.

15. A one-piece litter box comprising, in combination:
a container having a base wall with sidewalls extending vertically upward from edges of the base wall to form a hollow interior space;
wherein a top opening is formed by upper edges of the sidewalls;
wherein an entrance opening is formed in one of the sidewalls;
wherein the sidewalls form a height of the container which is at least fifteen inches;
wherein the entrance opening is spaced below the top opening and is spaced at least six inches above the base wall of the container;
wherein the entrance opening is circular and has a diameter in the range of about eight inches to about ten inches;
wherein the entrance opening is laterally centered on the sidewall in which the entrance opening is formed;
wherein the sidewalls are free of any openings other than the entrance opening;
wherein the entrance opening is free of coverings so that the animal can see through the entrance opening while within the hollow interior space; and
wherein the sidewalls form a height of the container which substantially prevents the animal from seeing over the sidewalls while standing within the hollow interior space;
whereby the animal faces the entrance opening while within the hollow interior space to see out of the container through the entrance opening and thereby substantially avoid escape of urine, feces and litter through the entrance opening when the animal is within the container.

16. The litter box according to claim 15, wherein each of the sidewalls are continuous except for the entrance opening.

17. The litter box according to claim 15, wherein the entrance opening is spaced above a bottom of the container a distance equal to at least forty percent of the height of the container.

18. The litter box according to claim 15, wherein the top opening is entirely open and free of any covering.

19. The litter box according to claim 15, wherein the container is molded of an opaque plastic material.

20. The litter box according to claim 15, wherein the container is molded of a plastic material including an antimicrobial material.

21. The litter box according to claim 1, wherein an interior surface of the container is seamless, interfaces between the sidewalls are each rounded, and interfaces between the base wall and the sidewalls are each rounded.

22. The litter box according to claim 21, wherein liter is placed directly onto the base wall.

23. The litter box according to claim 15, wherein an interior surface of the container is seamless, interfaces between the sidewalls are each rounded, and interfaces between the base wall and the sidewalls are each rounded.

24. The litter box according to claim 23, wherein liter is placed directly onto the base wall.
